(19) United States
(12) Patent Application Publication
(10) Pub. No.: US 2026/0072498 A1
(43) Pub. Date: Mar. 12, 2026

(54) Systems and Methods for Dynamic Densification of Streamed Assets Based on Tracked User Focus

(71) Applicant: Illuscio, Inc., Culver City, CA (US)

(72) Inventor: Joseph Nordling, Roeland Park, KS (US)

(73) Assignee: Illuscio, Inc., Culver City, CA (US)

(21) Appl. No.: 18/883,647

(22) Filed: Sep. 12, 2024

(51) Int. Cl. G06F 3/01; G06T 3/4092

(52) U.S. Cl. CPC G06F 3/013; G06T 3/4092

(57) ABSTRACT

A streaming system performs a dynamic densification of streamed content based on tracked user focus. The streaming system streams different content having a common classification to one or more users, and tracks a focus of the one or more users on different parts of the different content. The streaming system receives a request for new content, classifies the new content with the common classification, and streams a first parts of new content with greater detail than second parts of the new content in response to the request based on corresponding first parts from the different parts of the different content receiving more of the focus than corresponding second parts from the different parts of the different content.

### BACKGROUND

Digital content streaming, especially streaming of digital content that involves three-dimensional (3D) assets or a 3D environment, imposes significant loads on the data networks used to distribute the content. Some data networks, connections, or endpoints may have insufficient bandwidth for the amount of data required to stream 3D content without buffering, stuttering, lag, or other degradations in the 3D content experience. For instance, initially loading the 3D content may take several seconds or more, and then each change to the 3D content caused by a user interaction or programmed animation may result in the system or experience becoming temporary unresponsive as additional data is streamed over the data network to visualize the change.

The 3D content may be compressed or streamed at a reduced resolution or level-of-detail in order to reduce the size or data of the 3D content. However, compression adds delay due to extra processing and/or compute time. Compression may also yield insufficient data reduction as the 3D formats are optimized with little compressible data. Lowering the resolution or level-of-detail involves uniformly decreasing the quality across the entirety of the 3D content which may result in an unacceptable user experience. For instance, lowering the resolution or level-of-detail across the 3D content may cause important visual elements of the 3D content to be lost or undifferentiable.

### BRIEF DESCRIPTION OF THE DRAWINGS

FIG. 1 illustrates an example of streaming a three-dimensional 3D content with dynamic densification in accordance with some embodiments presented herein.

FIG. 2 illustrates an example of generating a personalized densification model that tracks the prioritization assigned to different elements or parts of different 3D content with a particular classification in accordance with some embodiments presented herein.

FIG. 3 illustrates an example of a prioritization heatmap for content of a particular classification in accordance with some embodiments presented herein.

FIG. 4 illustrates an example of generating a Gaussian splat for a parent node in a tree-based representation based on the Gaussian splats that are associated with the children nodes of the parent node in accordance with some embodiments presented herein.

FIG. 5 presents a process for defining a tree-based representation for streaming 3D content with dynamic densification in accordance with some embodiments presented herein.

FIG. 6 presents a process for streaming different parts or elements of new and previously unseen 3D content at different resolutions or levels-of-detail based on a heatmap that is generated from tracking user focus on parts or elements of previously viewed 3D content with the same or a similar classification in accordance with some embodiments presented herein.

FIG. 7 illustrates an example for the dynamic densification of streamed 3D content based on a prioritization of the streamed 3D content parts or elements by a set of users in accordance with some embodiments.

FIG. 8 presents a process for selecting a combination of Gaussian splats with different fidelity according to different priorities specified for parts or elements of the 3D content represented by the Gaussian splats and that satisfy streaming constraints in accordance with some embodiments presented herein.

FIG. 9 illustrates an example of performing the dynamic densification with generative AI based on user focus tracking in accordance with some embodiments presented herein.

FIG. 10 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided is a streaming system and associated methods for the dynamic densification of streamed assets based on tracked user focus. The streaming system tracks the parts of different three-dimensional (3D) content that users focus on, generates heatmaps that model or represent the user focus on the different parts of the 3D content, provides a classification to the 3D content or the generated heatmap for that 3D content, and uses the heatmap with a particular classification to dynamically densify new 3D content with a matching or similar classification prior to streaming the new 3D content.

The dynamic densification includes presenting parts of the 3D content that are identified in the heatmap as receiving most of the user focus or a threshold amount of user focus at a highest first resolution or a highest first level-of-detail and other parts of the 3D content at a progressively lower resolution or a reduced level-of-detail that is determined based on the lesser amount of user focus associated with those other parts in the heatmap. In some embodiments, the streaming system may provide two or more levels of densification with each additional level of densification increasing the resolution or detail of affected parts over the resolution or detail of parts receiving the prior level of densification.

The streaming system may adjust the densification amount according to streaming and/or rendering constraints. The streaming system may monitor network performance to determine an amount of available bandwidth for streaming content to a requesting client device. When the available bandwidth is limited, the streaming system may increase the amount by which the most important parts or elements of the 3D content vary in quality or fidelity from the lesser important parts or elements of the 3D content. When the available bandwidth is not limited, the streaming system may increase the densification for all parts or elements of the 3D content so that the most important parts or elements of the 3D content have a smaller quality or fidelity variance from the lesser important parts or elements of the 3D content. When the available bandwidth is not limited, the streaming system may also use generative artificial intelligence (AI) to further enhance the most important parts or elements of the 3D content by introducing new detail in those parts or elements of the 3D content.

The 3D content densification may be based on personalized heatmaps or collective user heatmaps. For instance, the streaming system may track the focus of a particular user across parts or elements of different 3D content, may generate one or more heatmaps that identify the parts or elements of the 3D content that received the most focus, viewing time, interaction, and/or other engagement from the particular user, and may perform the dynamic densification for new and/or previously unseen 3D content according to the one or more heatmaps that are generated based on the focus tracking of the particular user for 3D content with the same classification or similar parts or elements as the new and/or previously unseen 3D content. Alternatively, the streaming system may track the focus of multiple users across parts or elements of different 3D content, may generate one or more heatmaps that identify the parts or elements of the 3D content that received the most focus, viewing time, interaction, and/or other engagement from the multiple users, and may perform the dynamic densification for new and/or previously unseen 3D content for existing or new users according to the one or more heatmaps that are generated based on the collective user focus tracking.

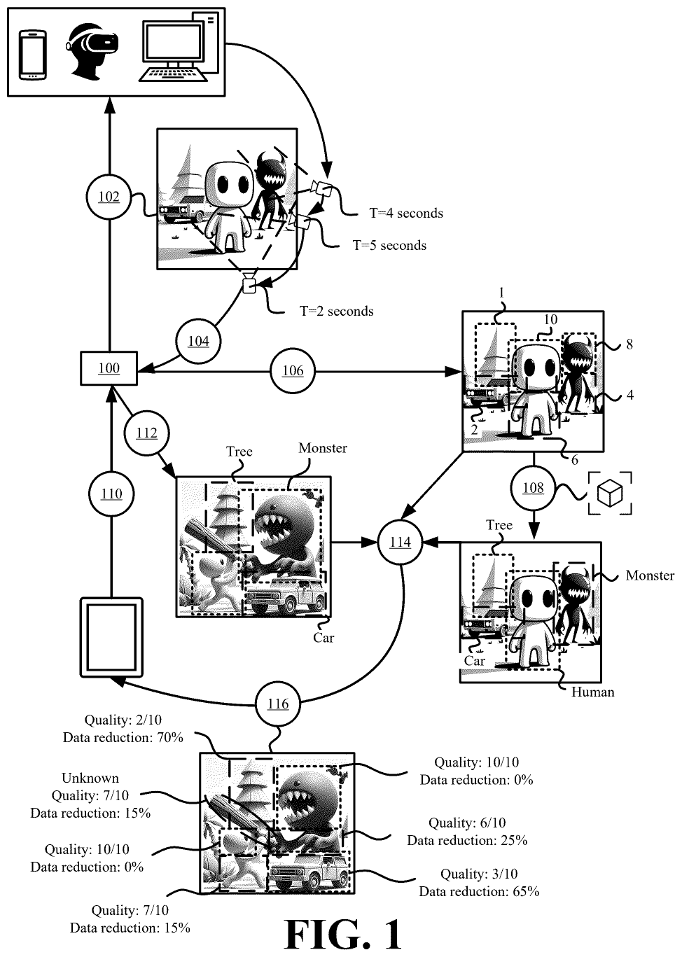

FIG. 1 illustrates an example of streaming a 3D asset or content with dynamic densification in accordance with some embodiments presented herein. Streaming system 100 streams or presents (at 102) different 3D content to one or more users, and tracks (at 104) the user focus, dwell time, or other engagement with parts or elements of the different 3D content.

Streaming system 100 may track (at 104) the user focus, dwell time, or other engagement by tracking the movement of a virtual camera across the different 3D content and/or tracking the parts or elements of the different 3D content within the users' field-of-view. User focus on a particular part or element of 3D content increases the longer the particular part or element remains at or near the center of the field-of-view, when the user zooms in on the particular part or element (e.g., the particular part or element is in the foreground or frontmost relative to other parts or elements), and/or when the particular part or element is presented straight on without an angular offset. Streaming system 100 may also track (at 104) the user focus using eye tracking functionality of headsets, mobile devices, and/or sensors, cameras, or tracking peripherals that are associated with the client devices being used to receive and view the 3D content.

In some embodiments, tracking (at 104) the user focus relative to a particular part or element of 3D content may include associating a value to the primitives of the 3D content that form that particular part or element. The primitives may include meshes for a polygonal model or points of a point cloud. The value may be a time or scalar value that increases the longer those primitives are in the center of the field-of-view, are anywhere in the field-of-view, have no angular offset relative to the virtual camera, and/or receive user focus. In some other embodiments, tracking (at 104) the user focus relative to a particular part or element of 3D content may include associating a value to a classification of the particular part or element. For instance, the tracking (at 104) may associate a first value to a male character head classification, a second value to a monster head classification, a third value to a male character classification, and a fourth value to a monster classification.

Streaming system 100 prioritizes (at 106) the parts or elements of the 3D content based on the tracked (at 104) user focus. In some embodiments, the prioritization (at 106) includes generating a heatmap with values at positions that correspond to or map to different parts or elements of the 3D content and that quantify the viewing importance associated with corresponding parts or elements.

Streaming system 100 classifies (at 108) the 3D content and/or the prioritized (at 106) parts or elements in the heatmap. The classification (at 108) includes assigning labels or tags that identify the one or more objects represented by the 3D content or the identifying features of the 3D content. For instance, the labels or tags may specify the name of a 3D character or identifying features of the 3D character (e.g., pilot, astronaut, male, female, tall, short, arms, legs, head, torso, etc.). Similarly, the labels or tags may directly identify the one or more objects represented by the 3D content (e.g., ball, hat, train, sports car, truck, motorcycle, etc.) or the identifying features of the one or more objects (e.g., metallic, shiny, reflective, bright, round, etc.). Streaming system 100 may use various image or object recognition techniques for the 3D content classification (at 108).

Streaming system 100 receives (at 110) a request for new 3D content from a client device. The new 3D content may include a 3D asset for which there is no or insufficient user engagement, focus tracking, and/or prioritization, or may include a 3D asset that has not been requested before.

Streaming system 100 classifies (at 112) the new 3D content. Streaming system 100 may locally render the new 3D content and perform image or object recognition in order to classify (at 112) the new 3D content. In some embodiments, the new 3D content may be tagged with one or more labels or identifiers so that the classification (at 112) may be performed by retrieving the labels or identifiers.

Streaming system 100 retrieves (at 114) a prioritization that has been generated for different 3D content with the same or similar classification as the new 3D content. For instance, the new 3D content may include a 3D model of a first human character, a first monster, a first car, and a first tree, and streaming system 100 may have previously generated (at 106) a heatmap that prioritizes the different parts or elements for a second human character, a second monster, a second car, and a second tree based on the user focus tracking (at 104) performed on the previously streamed (at 102) 3D content.

Streaming system 100 streams (at 116) parts or elements of the new 3D content with a higher priority in the retrieved (at 114) prioritization at a first resolution, a first level-of-detail, and/or a greater densification of primitives, and streams (at 116) the parts or elements of the new 3D content with a lower priority in the retrieved (at 114) prioritization at a lower second resolution, a lower second level-of-detail, and/or a reduced densification of primitives relative to the parts or elements with the higher priority. In some embodiments, the dynamic densification of the new 3D content is conditioned on streaming constraints and/or rendering constraints of the requesting client device. For instance, streaming system 100 performs the dynamic densification when the available bandwidth does not permit all of the new 3D content to be streamed at the first resolution, the first level-of-detail, and/or the greater densification of primitives. The new 3D content may be part of a movie or animation such that delays in streaming the new 3D content may cause the movie or animation to experience buffering, stuttering, and/or other interruptions. Similarly, the new 3D content may be part of a spatial computing experience and any delays in streaming the new 3D content may cause the spatial computing experience to lag or fall behind user inputs. In some such embodiments, streaming system 100 performs the dynamic densification in order to maximize the resolution or detail for the parts or elements of the new 3D content that have a higher likelihood of drawing the user focus and achieves the data reduction for a seamless streaming experience by lowering the resolution or detail for the other parts or elements of the 3D content that have a lower likelihood of drawing the user focus.

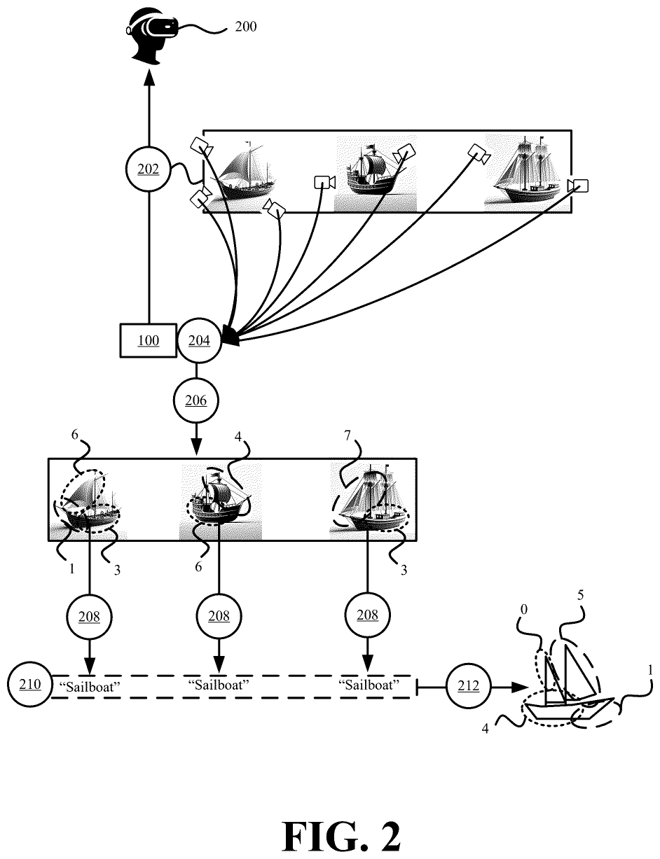

FIG. 2 illustrates an example of generating a personalized densification model that tracks the prioritization assigned to different elements or parts of different 3D content with a particular classification in accordance with some embodiments presented herein. Streaming system 100 streams (at 202) the 3D content with the particular classification to client device 200.

In FIG. 2, streaming system 100 streams (at 202) different mesh models, point clouds, and other 3D models of ships as part of different content requested by client device 200. For instance, a first request may be for a 3D video or 3D movie that includes a first 3D ship model, a second request may be for a second 3D ship model for editing, a third request may be for a spatial computing experience that includes a third 3D ship model.

Streaming system 100 monitors (at 204) the user focus as the 3D content is presented on client device 200. Streaming system 100 may monitor (at 204) the user focus based on requests from client device 200 that change the field-of-view from which the 3D content is presented. Specifically, the requests may change the position of a virtual camera and streaming system 100 may monitor (at 204) the user focus by tracking the amount of time that different parts or elements of the 3D content are presented at or near the field-of-view center as the position of the virtual camera changes.

In some embodiments, streaming system 100 monitors (at 204) the user focus using eye tracking sensors or cameras of client device 200. In some such embodiments, client device 200 may be a spatial computing headset with sensors that track the user gaze or pupil positions. The sensor data may be provided to streaming system 100. Streaming system 100 may track the amount of time that different parts or elements of the 3D content are within the user gaze by mapping the sensor data to the positions at which the different parts or elements of the 3D content are presented on a display of client device 200.

Streaming system 100 may monitor (at 204) the user focus using other sensors or techniques. For instance, streaming system 100 may monitor (at 204) the user focus based on an amount of time that different parts or elements of the 3D content are aligned directly in front of the virtual camera as opposed to being offset from the virtual camera by at least a threshold angle (e.g., offset by more than 5 degrees).

Streaming system 100 associates (at 206) different priority values to the different parts or elements of the 3D content based on the monitored (at 204) user focus. In some embodiments, the priority value for a particular part or element is a percentage or other value that is derived from the amount of time the user focus was on that particular part or element and the total time that the 3D content was viewed. In some other embodiments, the priority value is the amount of time that the particular part or element was tracked to be in the user focus.

Streaming system 100 may supplement the priority values by monitoring the user focus when the 3D content is requested again by client device 200 or when client device 200 requests different content with the same classification. For instance, streaming system 100 monitors the user focus as different 3D models of boats are streamed and presented on client device 200. Streaming system 100 may generate priority values for each 3D model of a boat from monitoring the user focus as each 3D model is presented.

Streaming system 100 classifies (at 208) the different 3D content. Streaming system 100 may use object or image recognition techniques to classify (at 208) the assets. For instance, streaming system 100 may render the first 3D content, provide the resulting visualization to an object recognition neural network, and obtain tags or labels for classifying the one or more object of the first 3D content. The classification tags or labels may be linked to the primitives of the first 3D content or to the first 3D content. For instance, the first 3D content may be defined with meshes, points, or other primitives of a forward sail, a rear sail, and a hull. Streaming system 100 isolates the primitives for each identified object, and attaches a classification label (e.g., forward sail, rear sail, hull, etc.) to the isolated primitives. Additionally, streaming system 100 determines that the first 3D content represents a sailboat and may associate a “sailboat” classification label to the first 3D content. In some embodiments, the first 3D content is defined from subcontent corresponding to separate 3D models or assets that collectively form the first 3D content. For instance, the 3D model of the sailboat may be generated from a first 3D asset of the forward sail, a second 3D asset of the rear sail, and a third 3D asset of the hull that are loaded into a 3D environment of the first 3D content.

In some embodiments, the 3D content may be defined with one or more classification labels. For instance, the content creator may generate the 3D content and assign the classification labels to the 3D content prior to or as part of uploading the 3D content to streaming system 100 for distribution.

Streaming system 100 determines (at 210) that the different 3D content are related or are representations of the same object based on the classification (at 208). Streaming system 100 generates (at 212) a single heatmap that combines the focus history of the individual user associated with client device 200 for different 3D content of the same classification or object.

Generating (at 212) the single heatmap may include combining the priority values that are tracked for common parts or elements of different 3D content with the same classification, and storing the combined priority values as a single set of priority values for the common parts or elements of any content with the same classification. Combining the priority values may include taking the average of the priority values assigned to a particular part or element or a weighted average that is biased based on the amount of user focus tracked for the particular part or element in the different 3D content. The heatmap may store the single set of priority values at positions that map to the parts or elements of the 3D content having that priority. Streaming system 100 may link the heatmap that is generated (at 212) for each classification to a profile that is maintained for the user associated with client device 200 whose individualized tracked focus is represented by the heatmap. Accordingly, streaming system 100 may generate different prioritization values for different users viewing the same content based on different user focus that streaming system 100 tracks for each user. Streaming system 100 uses the different prioritization values to stream different parts or elements of future requested content of the same classification with different fidelities to different users based on the prioritization of the different parts or elements that are tracked for each user in the heatmap generated for that user.

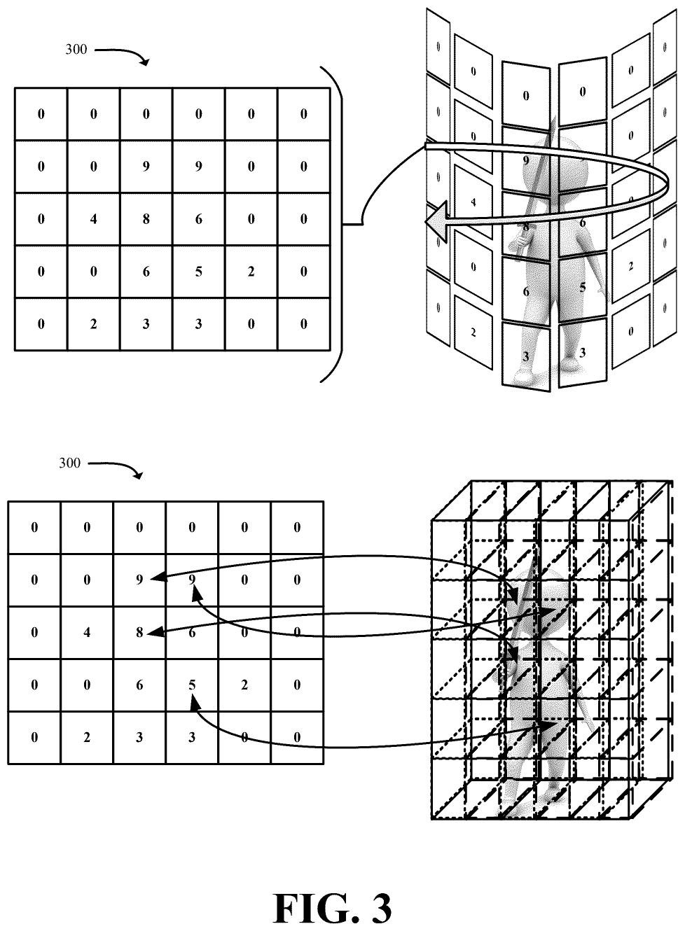

FIG. 3 illustrates an example of prioritization heatmap 300 for content of a particular classification in accordance with some embodiments presented herein. Prioritization heatmap 300 may be a series of prioritization values that are distributed about a two-dimensional (2D) plane, array, or data structure. The prioritization values may be mapped to different parts or elements of 3D content with the same classification as the heatmap. For instance, streaming system 100 may perform a 2D-to-3D wrapping or transform operation to map the prioritization values from the heatmap to corresponding parts or elements of the content with that prioritization similar to the mapping of a 2D texture to primitives of 3D content distributed about a 3D space. The heatmap may be anchored to a specific primitive or point-of-reference about the 3D content so that the prioritization values from heatmap 300 are consistently mapped to the same parts or elements of the content regardless of the orientation, rotation, scaling, or other transformations that are applied to the content.

In some embodiments, each value from the heatmap maps to a specific region or volume of space within the 3D space of 3D content rather to primitives or specific parts or elements of the 3D content. In some other embodiments, the heatmap may be defined with the coordinates of the primitives that form the 3D content structure. However, the color values and other values of the primitives may be replaced with the prioritization values.

Streaming system 100 uses the heatmaps and/or prioritization values from the heatmaps to select the resolution or level-of-detail at which different parts or elements of previously viewed and new or unviewed 3D content are streamed to a requesting client device. In particular, streaming system 100 dynamically adjusts the resolution or level-of-detail for different parts or elements of new 3D content (e.g., 3D content that was not previously requested by a client device or an user associated with the client device) according to the heatmap prioritization values that are based on the tracked user focus of similar parts or elements from previously viewed 3D content of the same or similar classification as the new 3D content.

In some embodiments, the prioritization values from a selected heatmap map to different levels in a tree structure. The different levels of the tree structure store representations for the different parts or elements of the content at different resolutions or levels-of-detail. In some other embodiments, the prioritization values combined with detected streaming constraints factor into which levels of the tree structure are selected in order to stream the different parts or elements of the content at different resolutions or levels-of-detail.

The tree structure may include leaf nodes that are associated with primitives or Gaussian splats for representing the content at the highest resolution or greatest level-of-detail. Two or more leaf nodes link to a parent node at a higher level in the tree structure. The parent node is associated with a Gaussian splat or splat primitive that represents the regions defined by the primitives or Gaussian splats of the linked leaf nodes at a lower resolution or level-of-detail. In other words, the Gaussian splat associated with a parent node defines a single primitive with a shape and visual characteristics that spans the smaller and more-detail shapes represented by the primitives or Gaussian splats associated with its children nodes. Moreover, the Gaussian splats associated with the parent node includes a single set of visual characteristics (e.g., color, transparency, reflectivity, and/or other values) that are derived from the different visual characteristics associated with each different primitive or Gaussian splat associated with its children nodes. Progressively higher levels of the tree structure are defined in a similar manner to represent increasingly larger regions of the content with less fidelity and data.

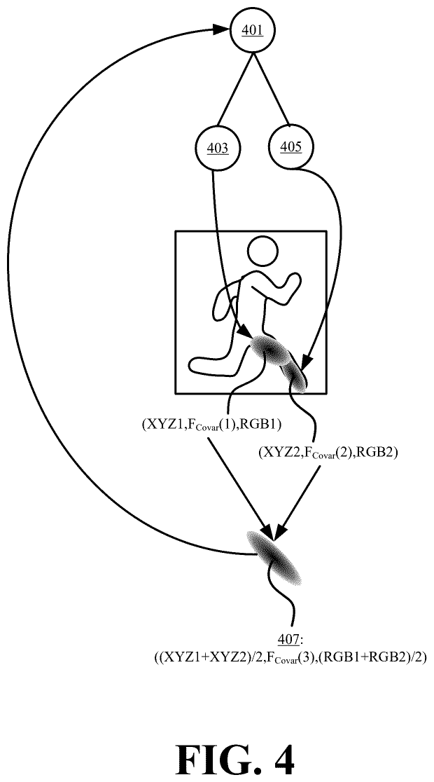

FIG. 4 illustrates an example of generating a Gaussian splat for a parent node in a tree-based representation based on the Gaussian splats that are associated with the children nodes of the parent node in accordance with some embodiments presented herein. Parent node 401 is linked to first child node 403 and second child node 405.

First child node 403 is associated with a first Gaussian splat and second child node 405 is associated with a second Gaussian splat. The first Gaussian splat corresponds to a first splat primitive (e.g., a 3D oval) that is defined over a first region of 3D space to represent a first part of the 3D model. The first Gaussian splat is defined with a first set of visual characteristics that include a first set of color values. The second Gaussian splat corresponds to a second splat primitive that is defined over a second region of 3D space to represent a neighboring second part of the 3D model. The second Gaussian splat is defined with a second set of visual characteristics that include a different second set of color values.

Streaming system 100 defines summarized Gaussian splat 407 for parent node 401 to span the regions of the first and second Gaussian splats and closely match the combined shape of first and second Gaussian splats. In other words, summarized Gaussian splat 407 is defined to represent the first part of the 3D model that is represented in more detail or more accurately by the first Gaussian splat and the second part of the 3D model that is represented in more detail or more accurately by the second Gaussian splat. The splat primitive associated with summarized Gaussian splat 407 is therefore larger in size and spans a larger region of the 3D model than the splat primitives associated with either the first Gaussian splat or the second Gaussian splat, and is intended to replace the first and second Gaussian splats when data reduction is needed for the first and second parts of the 3D model. The positional coordinates for summarized Gaussian splat 407 may be at the center of the positional coordinates for the first Gaussian splat and the second Gaussian splat or otherwise derived from the positional coordinates of the first Gaussian splat and the second Gaussian splat.

Streaming system 100 defines the visual characteristics of summarized Gaussian splat 407 based on the first set of visual characteristics of the first Gaussian splat and the second set of visual characteristics of the second Gaussian splat. In some embodiments, streaming system 100 defines the visual characteristics of summarized Gaussian splat 407 by averaging the first set of visual characteristics and the second set of visual characteristics. The visual characteristics may include red, green, blue, and other color values, a transparency value, a reflectivity value, and/or other values for rendering the Gaussian splat as part of a visualization. In some other embodiments, streaming system 100 takes the weighted average of the first set of visual characteristics and the second set of visual characteristics in order to define the visual characteristics of summarized Gaussian splat 407. The weighted average may be biased based on the size of the first Gaussian splat (e.g., size of the first region of space represented by the first Gaussian splat) relative to the size of the second Gaussian (e.g., size of the second region of space represented by the second Gaussian splat). Streaming system 100 may recursively move up from the leaf nodes to the root node of the tree-based representation and define summarized Gaussian splats for the nodes at each level removed from the leaf node layer similar to the definition of parent node 401 in FIG. 4.

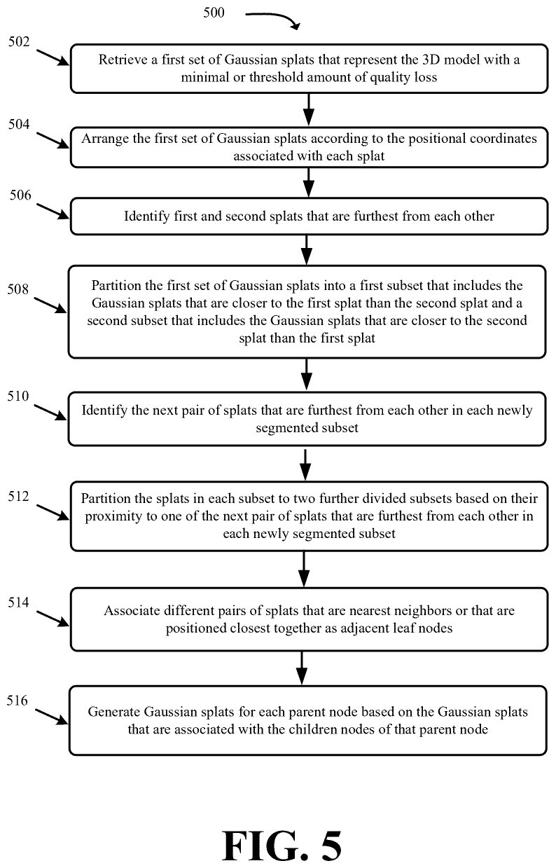

FIG. 5 presents a process 500 for defining a tree-based representation for streaming 3D content with dynamic densification in accordance with some embodiments presented herein. Process 500 is implemented by streaming system 100. Streaming system 100 includes one or more servers, devices, or machines with processing, memory, storage, network, and/or other hardware resources for the streaming of 3D content with dynamic densification based on tracked user focus.

Process 500 includes retrieving (at 502) a first set of Gaussian splats that represent the 3D content with a minimal or threshold amount of quality loss. The first set of Gaussian splats may be generated by streaming system 100 from the original primitives forming the 3D content or by converting 2D images of an object or scene to Gaussian splats using a Neural Radiance Field (NeRF). Alternatively, the first set of Gaussian splats may be generated by a third-party or obtained from a data repository of 3D content.

Process 500 includes arranging (at 504) the first set of Gaussian splats according to the positional coordinates associated with each splat. In some embodiments, arranging (at 504) the first set of Gaussian splats may include plotting the splats in a 3D space based on their positional coordinates. In some embodiments, arranging (at 504) the first set of Gaussian splats may include sorting the Gaussian splats in an array or other structure according to their positional coordinates.

Streaming system 100 then begins defining the leaf nodes of the tree-based representation using an Approximate Nearest Neighbor (ANN) approach, loading the Gaussian splats into a distance-based ANN, or using another technique for efficiently associating the Gaussian splats in the tree to specific regions or parts of the 3D content. To define the leaf nodes, process 500 includes identifying (at 506) first and second splats from the first set of Gaussian splats that are furthest from each other. Process 500 includes partitioning (at 508) the first set of Gaussian splats into a first subset that includes the Gaussian splats that are closer to the first splat than the second splat and a second subset that includes the Gaussian splats that are closer to the second splat than the first splat. Process 500 includes repeatedly identifying (at 510) the next pair of splats that are furthest from each other in each newly segmented subset and further partitioning (at 512) the splats in each subset to two further divided subsets based on their proximity to one of the next pair of splats that are furthest from each other in each newly segmented subset. Nearest neighboring splats or splats that are positioned closest together are determined when only two splats remain in a newly segmented subset.

Process 500 includes associating (at 514) different pairs of splats that are nearest neighbors or that are positioned closest together as adjacent leaf nodes of the tree-based representations. Moreover, the pair of splats that are nearest neighbors may be associated with leaf nodes that are linked to the same parent node, and the leaf nodes may also be arranged according to the proximity of the associated splats. In other words, the leaf nodes that are connected to the same parent node are nearest neighbors and neighboring leaf nodes that are connected to different parent nodes are the next nearest neighbors.

Process 500 includes generating (at 516) Gaussian splats for each parent node based on the Gaussian splats that are associated with the children nodes of that parent node. For instance, a parent node may be directly connected to first and second leaf nodes that are associated with first and second Gaussian splats, and generating (at 516) the Gaussian splats for the parent node may include defining a splat primitive that spans the space or region of the 3D model covered or represented by the first and second Gaussian splats and that has color values and other visual characteristics derived from the color values and other visual characteristics of the first and second splats.

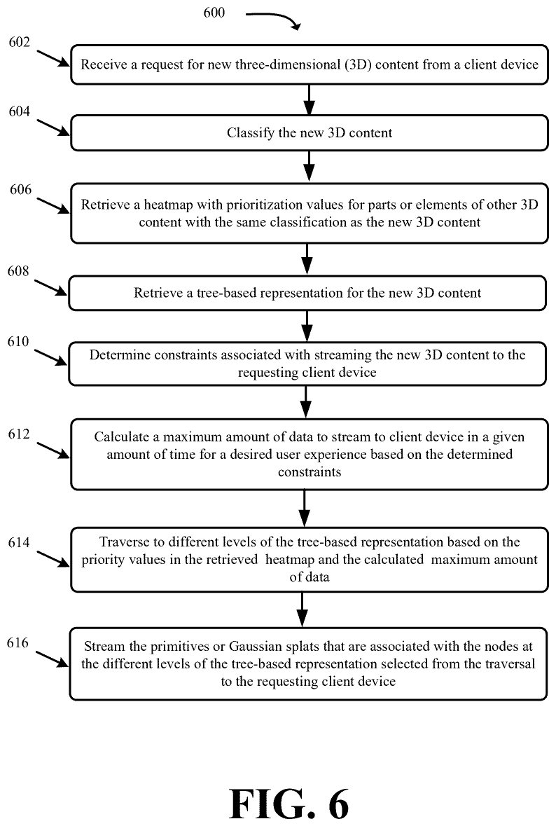

FIG. 6 presents a process 600 for streaming different parts or elements of new and previously unseen 3D content at different resolutions or levels-of-detail based on a heatmap that is generated from tracking user focus on parts or elements of previously viewed 3D content with the same or a similar classification in accordance with some embodiments presented herein. Process 600 is implemented by streaming system 100.

Process 600 includes receiving (at 602) a request for new 3D content from a client device. The request may include a name, path, Uniform Resource Locator (URL), or other identifier for accessing the new 3D content from streaming system 100. Streaming system 100 may determine that the new 3D content has not been previously requested or accessed by the client device or a user associated with the client device based on logs or user focus tracking history associated with the client device or the associated user. The new 3D content may include a mesh model, point cloud, or other 3D model of one or more objects for standalone viewing or for viewing as part of a 3D movie, animation, game, spatial computing experience, or other 3D environment that is interactive or that includes other 3D content.

Process 600 includes classifying (at 604) the new 3D content. In some embodiments, streaming system 100 may retrieve the new 3D content, render the objects or visual elements of the new 3D content, and perform object recognition to classify (at 604) the objects or visual elements. In some embodiments, the classification (at 604) may have been performed prior to or as part of the new 3D content being entered into streaming system 100 for distribution. In some such embodiments, the content creator may provide classification tags or labels with the new 3D content to identify the represented objects, and the classification (at 604) may include retrieving the classification tags or labels from a file associated with the new 3D content.

Process 600 includes retrieving (at 606) a heatmap with prioritization values for parts or elements of other 3D content with the same classification as the new 3D content that a user associated with the requesting client device focused on when previously presented with the other 3D content. Retrieving (at 606) the heatmap may include accessing a user profile of the user, and selecting a heatmap stored to the user profile with a classification tag or label that matches a classification tag or label associated with the new 3D content.

Process 600 includes retrieving (at 608) a tree-based representation for the new 3D content. Streaming system 100 may use the name, path, URL, or other identifier from the request to locate a stored copy of the new 3D content and/or the tree-based representation that is generated for the new 3D content. The tree-based representation defines the different parts or elements of the new 3D content at different resolutions or levels-of-detail using Gaussian splats that are associated with the nodes at different levels of the tree-based representation. The different parts or elements of the new 3D content may correspond to distinct regions or volume in a 3D space encompassing the new 3D content or surfaces or features of the new 3D content that are originally defined by one or more primitives.

Process 600 includes determining (at 610) constraints associated with streaming the new 3D content to the requesting client device. The constraints may be based on network performance and/or rendering performance of the client device. For instance, the network path connecting streaming system 100 to the requesting client device may be congested, experience high packet loss, and/or have limited available bandwidth that restricts the amount of data that may be streamed from streaming system 100 to the requesting client device in a given amount of time. Similarly, the rendering resources of client device (e.g., processor, memory, Graphics Processing Unit (GPU), and/or other resources associated with generating visualizations of the 3D content) may be limited such that regardless of the amount of data that is streamed from streaming system 100, the client device is only able to process and/or render a certain amount of data. In fact, streaming the new 3D content with too much data or at too high of a resolution for a client device with limited rendering resources may result in a degraded user experience in which animations or transitions are delayed, incomplete, suffer from tearing, or the responsiveness of the client device is not real-time or within an acceptable threshold.

Process 600 includes calculating (at 612) a maximum amount of data to stream to client device in a given amount of time for a desired user experience based on the determined (at 610) constraints. In some embodiments, achieving the desired user experience may include streaming the new 3D content at a collective level-of-detail and with a collective amount of data that is within the determined (at 610) streaming and/or rendering constraints and that produces a seamless and uninterrupted experience on the client device with the least amount of quality loss across the new 3D content. In other words, the desired user experience is one in which the client device renders the new 3D content data at a particular frame rate given the network conditions and rendering resources of the client device with the least amount of quality loss across the new 3D content. In some embodiments, achieving the desired user experience may include streaming the new 3D content at a collective level-of-detail that allows streaming system 100 and the client device to update the new 3D content in response to user input or programmatic changes within a specified time threshold so that the user experience is seamless and continuous.

Process 600 includes traversing (at 614) to different levels of the tree-based representation based on the priority values in the retrieved (at 606) heatmap and the calculated (at 612) maximum amount of data. The traversal (at 614) includes selecting nodes that maximize the resolution or level-of-detail for the primitives or Gaussian splats representing the prioritized parts or elements of the new 3D content and that increase data reduction by progressively lowering the resolution or level-of-detail for the primitives or Gaussian splats representing the parts or elements of the new 3D content associated with decreasing priority values. The traversal (at 614) also includes modifying the depth of the traversals associated with the different priority values for the different parts and elements of the new 3D content until the total data of the Gaussian splats associated with the nodes at the different traversed levels of the tree-based representation is within the calculated (at 612) maximum amount of data. For instance, priority values of 8-10 for a first set of elements may initially map to the leaf nodes of the tree representing the first set of elements at the highest resolution, priority values of 4-7 for a second set of elements may initially map to the parent nodes, one level above the leaf nodes, representing the second set of elements at the next highest resolution, and priority values of 1-3 for a third set of elements may initially map to the grandparent nodes, two levels above the leaf nodes, representing the third set of elements at a reduced resolution. If the collective amount of data associated with the Gaussian splats of the selected nodes exceeds the calculated (at 612) maximum amount of data, streaming system 100 may begin with moving one level up the tree for the lowest priority elements before reducing the quality for other elements of the new 3D content.

Process 600 includes streaming (at 616) the primitives or Gaussian splats that are associated with the nodes at the different levels of the tree-based representation selected from the traversal (at 614) to the requesting client device. The streamed (at 616) primitives or Gaussian splats generate the new 3D content with parts or elements of the new 3D content at different resolutions or levels-of-detail selected based on the priority values associated with those parts or elements in the retrieved (at 606) heatmap and with the cumulative data encoded to the streamed (at 616) primitives or Gaussian splats being within the calculated (at 612) maximum amount of data for the desired user experience.

Process 600 streams the requested 3D content with parts or elements at different fidelity based on a heatmap that is customized according to the tracked user focus of the requesting user. In other words, the streamed content is personalized based on the parts or elements of similarly classified content that the user has previously prioritized. Accordingly, streaming system 100, by execution of process 600, may prioritize elements of the same 3D content differently for different users based on different engagement or interest of the users as determined from the separate focus tracking of each user.

In some embodiments, the heatmaps are generated based on the overall or collective prioritization of the content parts or features rather than the individualized prioritization of a single user. In some such embodiments, streaming system 100 may perform the dynamic densification for new 3D content and for new users that are not associated with any personalized densification models or individualized heatmaps using the heatmaps generated from the overall or collective prioritization of other users.

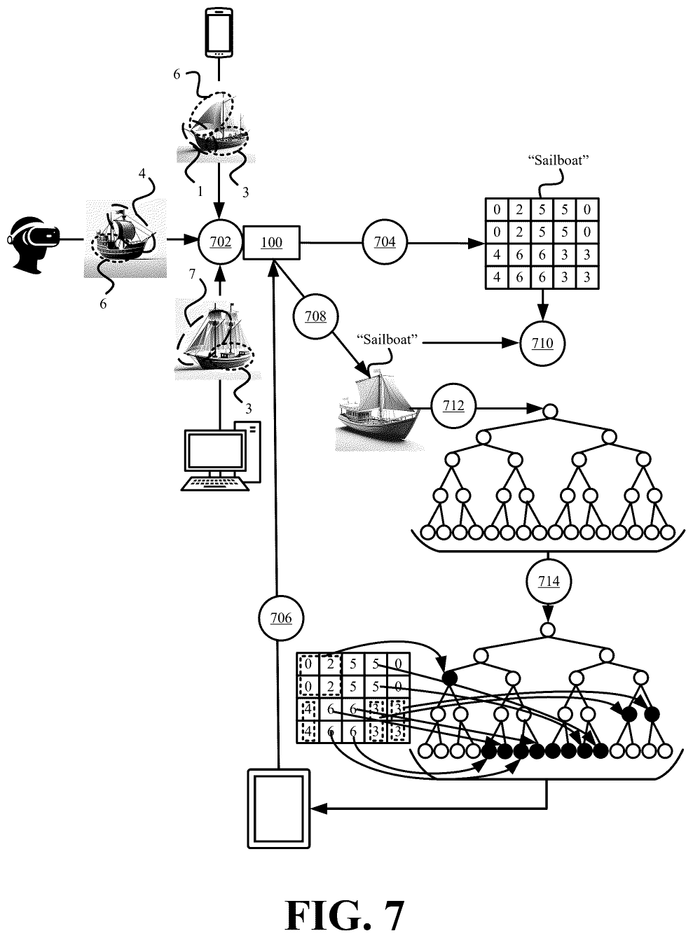

FIG. 7 illustrates an example for the dynamic densification of streamed 3D content based on a prioritization of the streamed 3D content parts or elements by a set of users in accordance with some embodiments. Streaming system 100 aggregates (at 702) focus data related to different parts or elements of content with a particular classification from multiple client devices and/or different users.

Streaming system 100 generates (at 704) one or more heatmaps with priority values derived from the cumulative amount of time that the users focus on distinct parts or elements of the content. Generating (at 704) the heatmap may include generating personalized heatmaps for each user based on the tracked focus of each user on the distinct parts or elements of the content, and combining the personalized heatmaps to generate a classification-specific heatmap for the content with the particular classification. Streaming system 100 associates the generated (at 704) heatmap with the particular classification.

Streaming system 100 receives (at 706) a request for new 3D content from a new user. The new 3D content may include content that streaming system 100 has yet to stream or otherwise distribute to any users or requesting client devices. The new user may include a user that streaming system 100 has not collected any focus data from.

Streaming system 100 classifies (at 708) the new 3D content with the particular classification. The classification (at 708) may be included in the new 3D content metadata or otherwise tagged or linked to the new 3D content. Alternatively, streaming system 100 may classify (at 708) the new 3D content based on the shapes, structures, and/or colors of the new 3D matching shapes, structures, and/or colors that are unique to the particular classification.

Streaming system 100 selects (at 710) the heatmap that is associated with the particular classification and that was generated (at 704) based on the collective tracking of the set of users. Streaming system 100 retrieves (at 712) a tree-based representation with Gaussian splats at different levels of the tree-based representation that encode different parts or elements of the new 3D content at different fidelity and/or levels-of-quality.

Streaming system 100 selects and streams (at 714) Gaussian splats from different levels of the tree-based representation based on priorities assigned in the heatmap to the parts or elements of the new 3D content represented by those Gaussian splats. For instance, streaming system 100 selects and streams (at 714) primitives or Gaussian splats associated with the leaf nodes to represent parts or elements of the new 3D content with the greatest or maximum priority values in the heatmap, and selects and streams (at 714) primitives or Gaussian splats associated with nodes at higher levels in the tree-based representation to represent parts or elements of the new 3D content with increasing lower priority values in the heatmap.

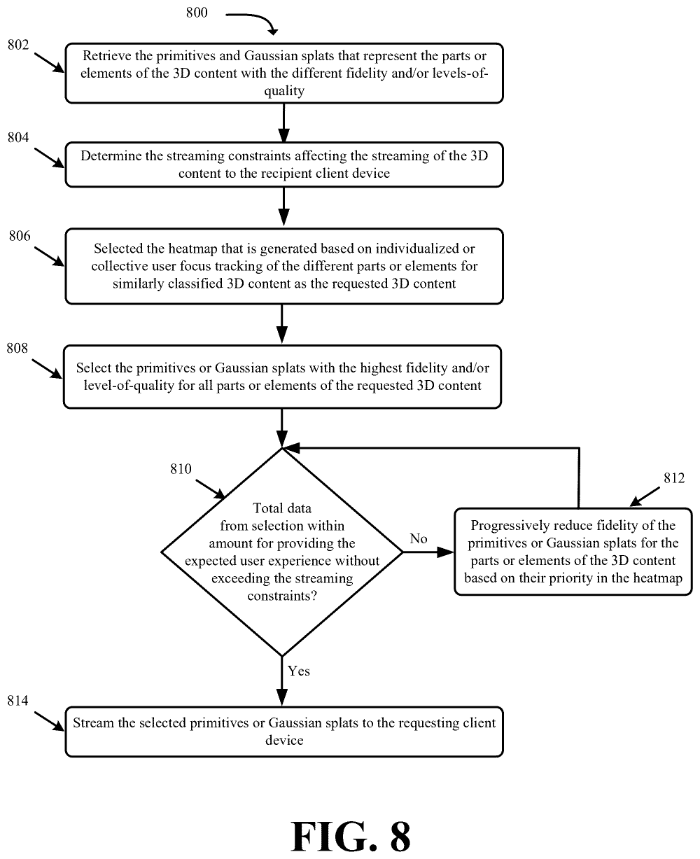

Streaming system 100 may use different techniques or algorithms to select the combination of nodes at different levels of the tree structure that maximize quality at the highest priority regions, minimize quality and data at the lowest priority regions, and collectively represent the requested 3D content with a collective amount of data that provides a desired user experience on the requesting client device in view of the network performance and/or the rendering performance of the requesting client device. FIG. 8 presents a process 800 for selecting a combination of Gaussian splats with different fidelity and/or levels-of-quality according to different priorities specified for parts or elements of the 3D content represented by the Gaussian splats and that satisfy streaming constraints in accordance with some embodiments presented herein.

Process 800 includes retrieving (at 802) the primitives and Gaussian splats that represent the parts or elements of the 3D content with the different fidelity and/or levels-of-quality. Retrieving (at 802) the primitives and Gaussian splats may include retrieving the tree-based representation for the 3D content.

Process 800 includes determining (at 804) the streaming constraints affecting the streaming of the 3D content to the recipient client device. The streaming constraints may include network constraints as well as a rendering constraints associated with the recipient client device.

Process 800 includes selecting (at 806) the heatmap that is generated based on individualized or collective user focus tracking of the different parts or elements for similarly classified 3D content as the requested 3D content. The heatmap is defined with different priority values for the different parts or elements of the 3D content.

Process 800 includes selecting (at 808) the primitives or Gaussian splats with the highest fidelity and/or level-of-quality for all parts or elements of the requested 3D content. The selection (at 808) may include selecting the primitives or Gaussian splats that are associated with the leaf nodes of the requested 3D content tree-based representation.

Process 800 includes determining (at 810) whether the data associated with the selected primitives or Gaussian splats is within the total amount of data for providing client device with the expected user experience without exceeding the streaming constraints. In response to determining (at 810—No) that the data associated with selected primitives or Gaussian splats exceeds the total amount of data, process 800 includes progressively reducing (at 812) fidelity and/or quality of the primitives or Gaussian splats for the parts or elements of the 3D content based on their priority in the heatmap, and determining (at 810) whether the data associated with the selected primitives or Gaussian splats is within the total amount of data. Progressively reducing (at 812) the fidelity and/or quality includes reducing the fidelity and/or quality of the primitives or Gaussian splats for the parts or elements with the lowest priority in the heatmap by one level. If the reduction is insufficient, the progressive reduction (at 812) further includes reducing the fidelity and/or quality of the primitives or Gaussian splats for the parts or elements with the next lowest priority in the heatmap by one level and the fidelity and/or quality of the primitives or Gaussian splats for the parts or elements with the lowest priority by another level. The fidelity or quality reduction continues for each previously reduced primitives or Gaussian splats and starts for the primitives or Gaussian splats of the next lowest priority in the heatmap until the Gaussian splats associated with each priority cannot be reduced further. In response to determining (at 810—Yes) that the data associated with selected primitives or Gaussian splats is within the total amount of data, process 800 includes streaming (at 814) the selected primitives or Gaussian splats to the requesting client device.

Streaming system 100 may use generative AI to enhance the resolution and/or detail of high priority parts or elements of the 3D content beyond the resolution and/or detail encoded by the 3D content primitives or Gaussian splats when sufficient streaming resources are available. For instance, streaming system 100 may generate new primitives or Gaussian splats to stream with the primitives or Gaussian splats of the 3D content when there is unused bandwidth to stream the generated 3D content primitives or Gaussian splats to the requesting client device without degrading the user experience for the requesting client device.

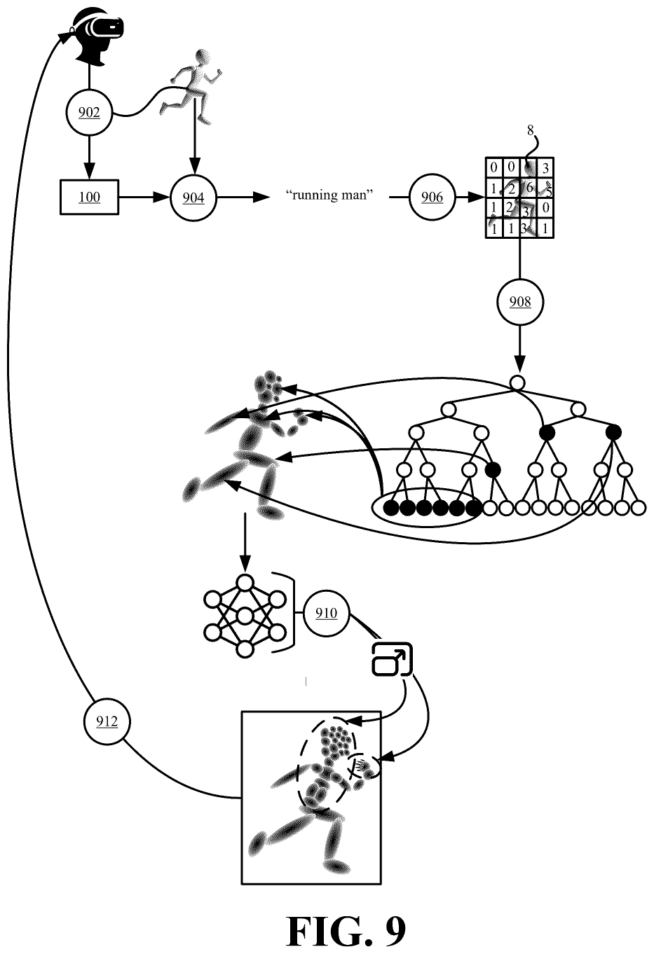

FIG. 9 illustrates an example of performing the dynamic densification with generative AI based on user focus tracking in accordance with some embodiments presented herein. Streaming system 100 receives (at 902) a request for content. Streaming system 100 classifies (at 904) the requested content, and retrieves (at 906) a heatmap that prioritizes different parts or elements of content with the same classification as the requested content.

Streaming system 100 selects (at 908) Gaussian splats to represent different parts of the requested content at different resolutions, fidelities, and/or quality levels according to the prioritization specified for those parts in the heatmap. Streaming system 100 determines that the total data associated with the selected (at 908) Gaussian splats is less than the total maximum amount of data that may be streamed for a desired user experience on the requesting client device. Accordingly, streaming system 100 uses generative AI to add (at 910) detail or higher resolution Gaussian splats to the highest priority parts of the 3D content. For instance, streaming system 100 may invoke a NeRF neural network, provide the selected (at 908) Gaussian splats as inputs, and select the head and torso parts of the 3D content for enhancement by the NeRF neural network. Alternatively, streaming system 100 may retrieve the original primitives (e.g., meshes or points) that originally defined the head and torso parts of the 3D content and may use one or more 3D model enhancement techniques to replace the original primitives with a larger number of smaller primitives to redefine the hard and torso parts with greater detail.

Streaming system 100 streams (at 912) the enhanced representation of the requested 3D content to the requesting client in order to improve the quality of the 3D content for the high priority parts beyond the available or original quality. In particular, streaming system 100 streams (at 912) the selected Gaussian splats with the generative AI created primitives or Gaussian splats for improving the fidelity for the parts that are designated to be most important in the heatmap.

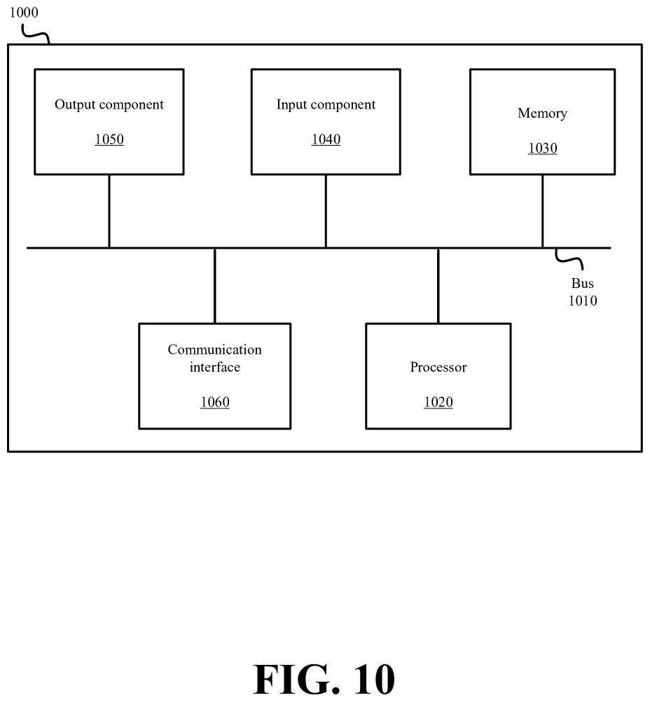

FIG. 10 is a diagram of example components of device 1000. Device 1000 may be used to implement one or more of the tools, devices, or systems described above (e.g., streaming system 100, client device 200, etc.). Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more LEDs, etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more. ” Where only one item is intended, the terms “one,” “single,” “only,” or similar language is used. Further, the phrase “based on” is intended to mean “based, at least in part, on” unless explicitly stated otherwise.

1. A method comprising:
streaming a plurality of different content with a common classification to one or more users;
tracking a focus of the one or more users on different parts of the plurality of different content;
receiving a request for new content that is different than the plurality of different content;
classifying the new content with the common classification; and
streaming a first set of parts from the new content with greater detail than a second set of parts from the new content in response to the request based on a corresponding first set of parts from the different parts of the plurality of different content receiving more of the focus than a corresponding second set of parts from the different parts of the plurality of different content.

2. The method of claim 1, wherein tracking the focus comprises:
monitoring an amount of time that each part from the different parts is at a center of a field-of-view.

3. The method of claim 1, wherein tracking the focus comprises:
measuring an amount of time that an eye gaze of the one or more users is on each part from the different parts.

4. The method of claim 1 further comprising:
generating a heatmap for the common classification, wherein generating the heatmap comprises associating a priority value to each part of the different parts of the plurality of different content based on a percentage of the focus that is on that part of the plurality of different content.

5. The method of claim 1 further comprising:
selecting the first set of parts for the new content to have a first resolution; and
selecting the second set of parts for the new content to have a second resolution that is less than the first resolution.

6. The method of claim 1 further comprising:
generating a heatmap with a plurality of priority values that are defined for the common classification based on the tracking of the focus;
selecting the heatmap in response to classifying the new content with the common classification; and
adjusting an amount of detail at which a plurality of parts of the new content are streamed based on a mapping of the plurality of priority values to the plurality of parts.

7. The method of claim 1 further comprising:
generating a heatmap with a plurality of priority values that are defined for the common classification based on the tracking of the focus;
retrieving a tree structure comprising a plurality of nodes at different layers of the tree structure, wherein the plurality of nodes at the different layers that represent different parts of the new content at different levels-of-detail;
traversing the tree structure to a first set of nodes at a first layer that represent the first set of parts with a first level-of-detail based on a first set of priority values being defined in the heatmap at positions corresponding to the first set of parts; and
traversing the tree structure to a second set of nodes at a second layer that represent the second set of parts with a different second level-of-detail based on a second set of priority values being defined in the heatmap at positions corresponding to the second set of parts.

8. The method of claim 1 further comprising:
determining a set of streaming constraints affecting one or more of a delivery or rendering of the new content on a requesting client device;
determining that a total amount of data encoded to the first set of parts and the second set of parts selected for the new content exceeds the set of streaming constraints; and
reducing a level-of-detail associated with the second set of parts until the total amount of data does not exceed the set of streaming constraints.

9. The method of claim 1, wherein said streaming comprises:
selecting a first set of Gaussian splats that each encode a region of a first size to represent the first set of parts;
selecting a second set of Gaussian splats that each encode a region of a second size that is larger than the first size to represent the second set of parts; and
streaming the first set of Gaussian splats with the second set of Gaussian splats in response to the request for the new content.

10. The method of claim 1, wherein said streaming comprises:
selecting a first set of Gaussian splats from a first layer in a tree-based representation of the new content, wherein the first layer is encoded with the greater detail and the first set of Gaussian splats contain splat primitives that recreate the first set of parts with the greater detail;
selecting a second set of Gaussian splats from a second layer in the tree-based representation, wherein the second layer is encoded with lesser detail than the first layer and the second set of Gaussian splats contain splat primitives that recreate the second set of parts; and
streaming the first set of Gaussian splats with the second set of Gaussian splats in response to the request for the new content.

11. The method of claim 1, wherein classifying the new content comprises:
determining one or more objects represented by the new content; and
tagging the new content with identifiers for the one or more objects.

12. The method of claim 1 further comprising:
defining a plurality of priority values that are associated with the different parts of the plurality of different content based on the tracking of the focus;
mapping a first set of priority values from the plurality of priority values to positions in a three-dimensional (3D) space at which the first set of parts are located;
mapping a second set of priority values from the plurality of priority values to positions in the 3D space at which the second set of parts are located; and
increasing a resolution of the first set of parts relative to the second set of parts in response to the first set of priority values being greater than the second set of priority values.

13. A streaming system comprising:
one or more hardware processors configured to:
stream a plurality of different content with a common classification to one or more users;
track a focus of the one or more users on different parts of the plurality of different content;
receive a request for new content that is different than the plurality of different content;
classify the new content with the common classification; and
stream a first set of parts from the new content with greater detail than a second set of parts from the new content in response to the request based on a corresponding first set of parts from the different parts of the plurality of different content receiving more of the focus than a corresponding second set of parts from the different parts of the plurality of different content.

14. The streaming system of claim 13, wherein tracking the focus comprises:
monitoring an amount of time that each part from the different parts is at a center of a field-of-view.

15. The streaming system of claim 13, wherein tracking the focus comprises:
measuring an amount of time that an eye gaze of the one or more users is on each part from the different parts.

16. The streaming system of claim 13, wherein the one or more hardware processors are further configured to:
generate a heatmap for the common classification, wherein generating the heatmap comprises associating a priority value to each part of the different parts of the plurality of different content based on a percentage of the focus that is on that part of the plurality of different content.

17. The streaming system of claim 13, wherein the one or more hardware processors are further configured to:
select the first set of parts for the new content to have a first resolution; and
select the second set of parts for the new content to have a second resolution that is less than the first resolution.

18. The streaming system of claim 13, wherein the one or more hardware processors are further configured to:
generate a heatmap with a plurality of priority values that are defined for the common classification based on the tracking of the focus;
select the heatmap in response to classifying the new content with the common classification; and
adjust an amount of detail at which a plurality of parts of the new content are streamed based on a mapping of the plurality of priority values to the plurality of parts.

19. The streaming system of claim 13, wherein the one or more hardware processors are further configured to:
generate a heatmap with a plurality of priority values that are defined for the common classification based on the tracking of the focus;
retrieve a tree structure comprising a plurality of nodes at different layers of the tree structure, wherein the plurality of nodes at the different layers that represent different parts of the new content at different levels-of-detail;
traverse the tree structure to a first set of nodes at a first layer that represent the first set of parts with a first level-of-detail based on a first set of priority values being defined in the heatmap at positions corresponding to the first set of parts; and
traverse the tree structure to a second set of nodes at a second layer that represent the second set of parts with a different second level-of-detail based on a second set of priority values being defined in the heatmap at positions corresponding to the second set of parts.

20. A non-transitory computer-readable medium storing instructions that, when executed by one or more processors of a streaming system, cause the streaming system to perform operations comprising:
streaming a plurality of different content with a common classification to one or more users;
tracking a focus of the one or more users on different parts of the plurality of different content;
receiving a request for new content that is different than the plurality of different content;
classifying the new content with the common classification; and
streaming a first set of parts from the new content with greater detail than a second set of parts from the new content in response to the request based on a corresponding first set of parts from the different parts of the plurality of different content receiving more of the focus than a corresponding second set of parts from the different parts of the plurality of different content.
